(19) United States
(12) Patent Application Publication
(10) Pub. No.: US 2013/0054141 A1
(43) Pub. Date: Feb. 28, 2013

(54) Weighted Path Selection for Mapping Route Selection

(71) Applicants: Michael Adam Paluszek, Princeton, NJ (US); Mary Breton, Point Pleasant, NJ (US); Stephanie Thomas, West Windsor, NJ (US)

(72) Inventors: Michael Adam Paluszek, Princeton, NJ (US); Mary Breton, Point Pleasant, NJ (US); Stephanie Thomas, West Windsor, NJ (US)

(73) Assignee: Princeton Satellite Systems, Plainsboro, NJ (US)

(21) Appl. No.: 13/597,751

(22) Filed: Aug. 29, 2012

Related U.S. Application Data
(60) Provisional application No. 61/528,305, filed on Aug. 29, 2011.

(51) Int. Cl. G01C 21/00; G01C 21/36; G01C 21/34

(52) U.S. Cl. 701/488; 701/487; 701/538

(57) ABSTRACT

A route finding system comprising a memory, GPS device, library of maps, an optimization algorithm and means for capturing user input and outputting data. The user input includes points, goals, constraints and relative preferences. Goals and constraints include characteristics of the route such as the type of road, number of turns, and traffic. The relative preferences are converted into numerical weights, positive or negative. In addition, the system integrates social networks' ratings and comments to further enhance route selection.

### BACKGROUND OF THE INVENTION

1. Field of the Invention

The present invention generally relates to route mapping systems, and particularly to allow users to prioritize among wider navigation criteria such as turn direction, road quality, and scenery.

2. Background of the Invention

Drivers have become heavily dependent upon navigation applications and route guidance systems. A Global Positioning System (GPS) using satellites to send position information to terrestrial vehicles was first disclosed in Anderson et al (U.S. Pat. No. 3,384,891—issued 1968). The initial description of a route mapping system was presented in U.S. Pat. No. 4,086,632 to Lions (1976) and was limited to mapping between two endpoints. These two patents form the basis for nearly all vehicular and aircraft navigation today.

While the initial mapping applications automatically generated routes between two points, later improvements allowed for the addition of multiple waypoints. Nesbitt (U.S. Pat. No. U.S. 2007/0156326 A1, filed 2005) discloses a route planner whose waypoints indicate preferred geographic regions, points of interest and areas to avoid, as determined by the user.

Conversely, Krzanowski (U.S. patent 2010/0070166 A1, filed 2008) directs the user according to whether the area is desirous or to be avoided by utilizing a real features. Both Nesbitt and Krzanowski rely upon generalized geographic regions to plan routes without taking into account more localized and temporal route details.

A solution for optimizing routes for minimum distance and minimum time is presented by Scalf et al (U.S. Pat. No. 2010/0241342 A1, filed 2009). That route planner utilizes real-time travel estimates from traffic data. However, other localized hazards and hinderances such as flooding and temporary road closures are not considered.

Other solutions may take into account more individualized parameters. Rothschild (U.S. patents 2012/0109508 A1, filed 2011) and Mason et al (U.S. patent 2012/0131048A1, filed 2011) present mapping software with energy-efficient route planning. The latter is specifically designed to direct fleet vehicles. Both patents combine traffic data with terrain, vehicle, and driver characteristics to estimate energy use for various routes and select an optimal solution. However, the relative strengths of a user's preferences are not respected. Whereas, Tomita et al (U.S. Pat. No. 8,190,363, 2012) allows for right-turn preference to be taken into account, such as for delivery truck routing. The intended use of this feature is to assign routes to appropriately skilled drivers based on facility entry difficulty level.

Recently, social networking has been integrated into some mapping platforms like that of Blom et al (U.S. patent 2008/0293430 A1, filed 2007), which selects routes based on social spots or the locations of other users. Similarly, Forstall et al (U.S. patent 2012/0131048 A1, filed 2012) added a social aspect to mapping where other users' locations are visible during route planning. Finally, routes can be designed to travel near or to other members of a user's social network as in Birnie et al (U.S. Pat. No. 8,108,501—filed 2006). None of these patents feature the ability of other users in your network to rate or comment on specific road segments.

The methods for date input by the user in the patents above only employ text-based and graphical options. Severson (U.S. Pat. No. 7,953,552—issued 2011) discloses a further input method of speech-recognition in order to reduce the dangers inherent in a driver not watching the road. However, that patent is entirely limited to input methods into a navigation system and does not discuss actual route finding.

The previous patents and applications heretofore known are impaired by a number of disadvantages:

Route mapping is limited to choosing a single factor to optimize with such as distance, time, areal features, energy efficiency, or proximity to social network members. For example, one cannot find the most energy-efficient route between members of a social network.

Each only employs a small subset of the available optimization constraints mentioned in the patents above so that many potential combinations are unavailable. Thus, left-turn avoidance and negative areal feature avoidance is never proposed as a potential combination.

None of the proposed systems allows the user to consult a wider range of goal or constraint parameters such as quality of road surfaces, avoidance of merging onto highways, and public input from a social network.

Users are unable to express relative preference for certain parameters. For instance, a user cannot indicate that minimizing mileage is most important to them followed by minimizing merges onto highways.

### BACKGROUND OF THE INVENTION

### Objects and Advantages

Therefore, the present invention has the following objects and advantages:

a. to provide a route finding system where the user can have multiple optimization goals;

b. to provide a route finding system where the user can specify a much larger number of combinations of optimization constraints;

c. to provide the user with many more options for optimization goals and constraints;

d. to provide the user the ability to indicate relative strength of preferences by assigning relative weights to route goals and constraints.

Further objects and advantages are to provide a route finding system with a simple graphical user interface, which allows users to rate road segments based on a variety of factors such as road surface, traffic flow, and ease of access, which is integrated with a social networking platform to generate a route map of member preferences and comments which are easily accessed by the users, to provide simple input options to a use through a variety of interfaces including graphics, text-entry, and speech-recognition.

### SUMMARY OF THE INVENTION

1. In accordance with the present invention a route finding system comprises a route finding device having a memory, a processor, a GPS device, a software means for route finding using an optimization algorithm

2. an electronic means to capture a user's inputs and store them

3. a display monitor to show optimization goals and constraints and to output routes and an electronic means for said user to specify their relative strength of preference among the choices for the optimization goals and constraints

### DRAWINGS

### Figures

In the drawings, closely related figures have the same number but different suffixes.

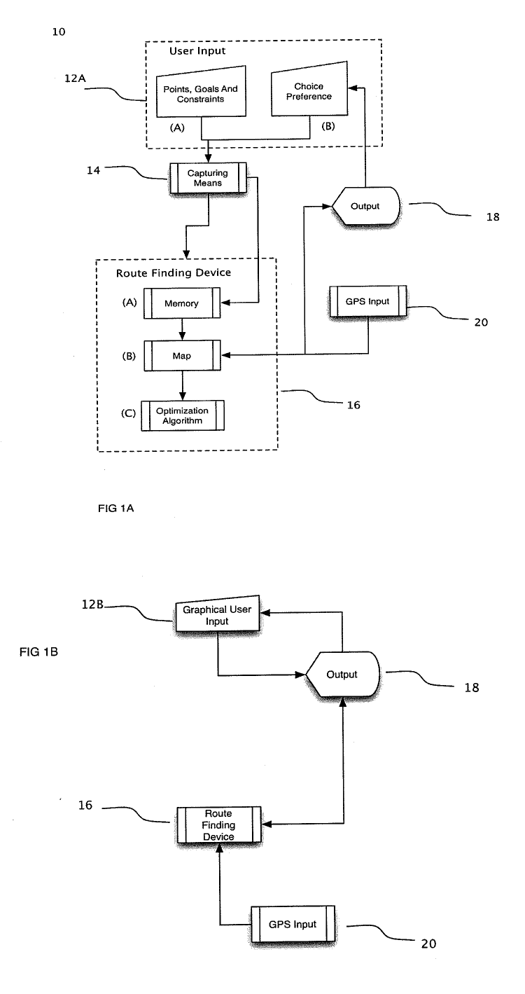

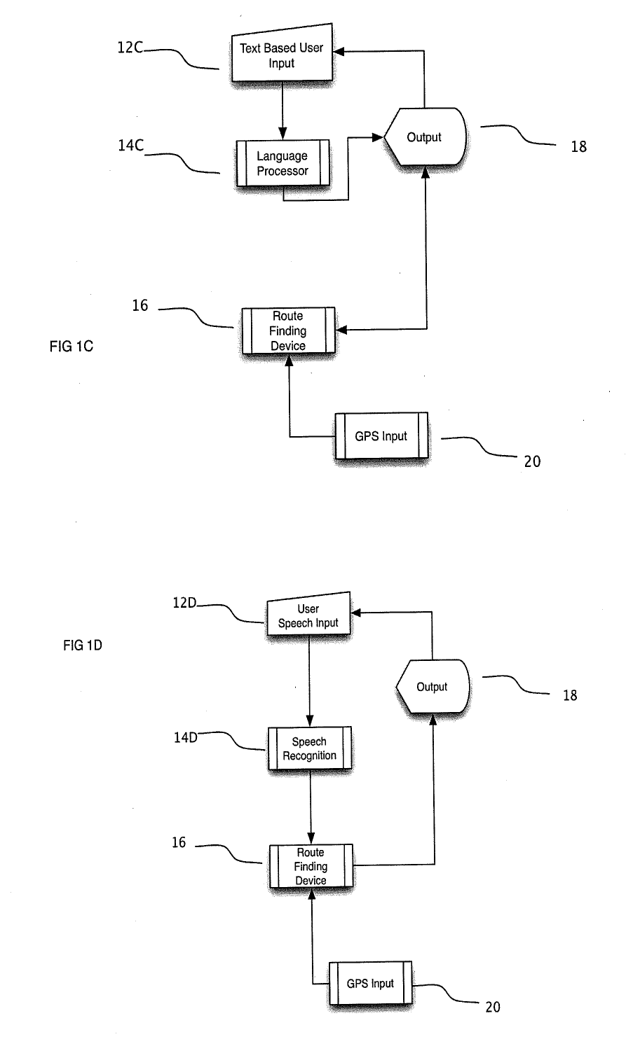

FIGS. 1A to 1D show various aspects of a route finding system supplied by a user with points, goals, and constraints having a means for capturing such input, supplying it to a route finding device and displaying a route to the user.

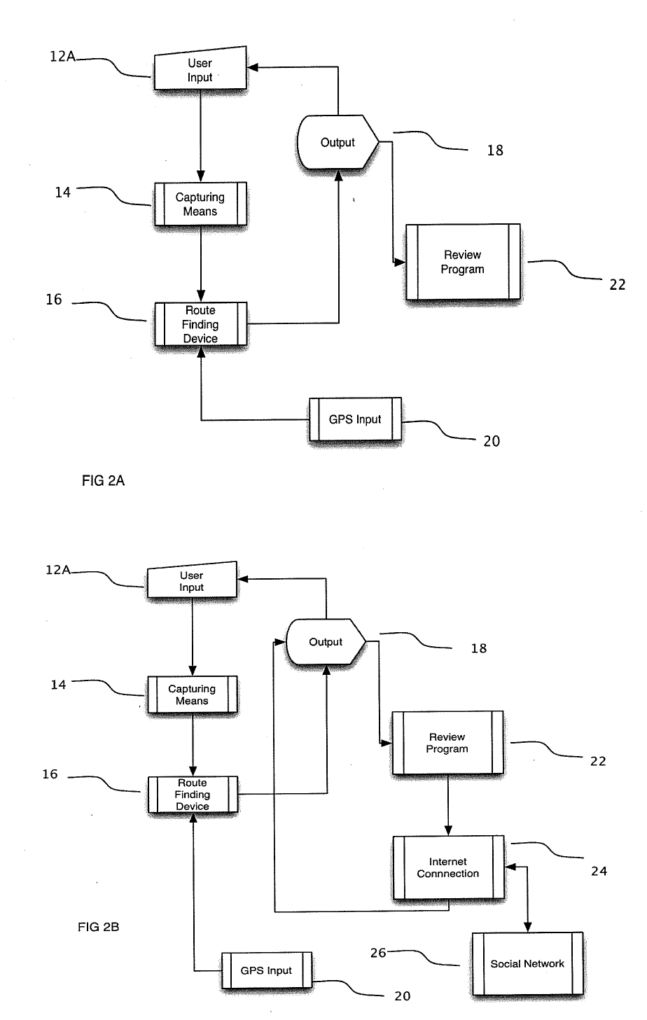

FIGS. 2A and 2B show a similar system with various combinations of user and social networked supplied data.

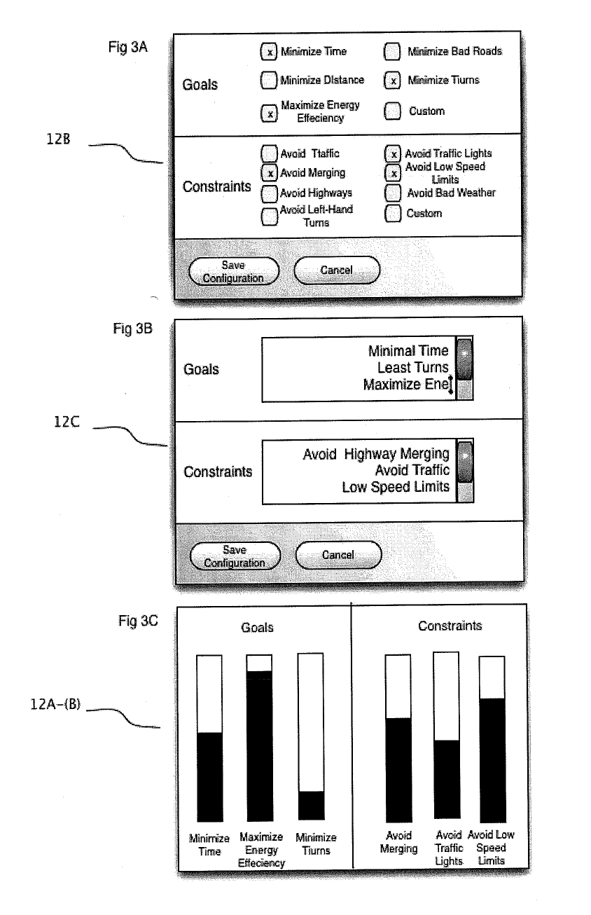

FIGS. 3A, 3B, and 3C show various aspects of user input including goal and constraint input as well as expression of relative preferences.

### DETAILED DESCRIPTION

In the following description, for purposes of explanation, specific numbers, materials and configurations are set forth in order to provide a thorough understanding of the invention. It will be apparent, however, to one having ordinary skill in the art, that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in an embodiment” in various places in the specification are not necessarily all referring to the same embodiment.

FIG. 1A—Preferred Embodiment

A preferred embodiment of the route finding system of the present invention is illustrated in FIG. 1A. The system takes in user input 12A which consist of a destination and can further include way points to pass through between an origin and the destination. The user also chooses among one or more optimization goals 12A-(A) such as maximizing energy-efficiency. Other goals could consist of minimal time, minimal distance, etc. Furthermore, the user can specify constraints such as avoid merging onto highways, avoid traffic, avoid left-turns, etc. The user may also indicate strength of preference among their goals and constraints 12A-(B). They may strongly wish to avoid merging, only moderately dislike left-turns, and only wish to travel the shortest route after meeting those two criteria.

All user input goes through an electronic capturing means 14 and is sent to a route finding device 16. An origin is determined using a GPS device 20. The route finding device 16 is composed of a memory 16-(A), a library of maps 16-(B) and an optimization algorithm 16-(C). Upon determination of an appropriate route, an output is expressed to the user via an output device 18 such as a display, speaker, etc. The output also can present the user with the goal, constraint, and preference that have previously been selected.

FIGS. 1B to 1D,2A to 2B, and 3A to 3C

Additional embodiments are shown in FIGS. 1B, 1C, 1D, 2A, 2B, 3A, 3B, and 3C. In FIG. 1B the system's user inputs of points, goals, constraints and preferences are received through a graphical user interface 12B on the display, further illustrated in FIG. 3A; FIG. 1C they are received through a text-based interface 12C, further illustrated in FIG. 3B; in FIG. 1D they are received through a speech-based interface 12D.

FIG. 2A extends the preferred embodiment to include a review program 20 to which the user adds ratings and comments and can reference via the output 18. In FIG. 2B, the review program is connected to the internet 24 and can access a social network 26 and from there the ratings and comments of other users.

### Operation—FIGS. 1, 2, 3

The manner of using the route finding system to find an optimal route is now presented.

Namely, a user inputs at least a destination if not other way-points and at least one goal 12A-(A) via an electronic capturing means 14 that are stored in a memory 16-(A). Next, a GPS device supplies an origin 20 and the points are located on a map 16-(B). Routes between those points are examined and evaluated with an optimization algorithm 16-(C). Finally, an optimal route is then chosen and sent to an output 18.

There are various possibilities for capturing user input 14A. The user can select input graphically using a graphical user interface 12B sent to the output 18. In an alternative configuration, a user can type textual inputs 12C into a language processor 14C. A further possibility is a sound input is captured 12D and processed by a speech-processor 14D.

Relative preferences can be input. A graphical embodiment of such input is shown in FIG. 3C, 12A-(A). In this embodiment the user can graphically indicate their relative preference and software converts these visual indicators into numerical weights which are sent to the route finding device 16.

The other major additional embodiment is shown in FIG. 2A; it allows users to input comments and ratings on road segments during and after they have travelled a route through a review program 22. A further configuration of this embodiment, as shown in FIG. 2B allows users to share their reviews on a social network 26 via an internet connection 24.

Advantages from the description above, a number of advantages of the presented route finding systems are made clear:
(a) Users will be able to select multiple optimization goals, which will give them more flexibility.
(b) Users will be able to specify a much larger number of combinations of optimization constraints, thus furthering the amount of control given to the user.
(c) By being able to assign relative weights to route goals and constraints, users well be able to better express their navigation preferences.
(d) In the embodiment including the review program 22, users will be able to annotate their routes, which will allow future route finding to take local road conditions, such as construction or poor quality road surface, into account.
(e) In the embodiment including sharing road information with members of a social network 26, users will be able to share local road information, further expanding the systems ability to evaluate the best routes.
(f) conclusions, Ramifications, and Scope

Therefore, the reader will see that the route finding system disclosed here can be used to find an optimal route between the user provided points, can provide the users with a large amount of flexibility in determining how routes are chosen, can provide more data than standard navigation systems by referencing the user's own ratings, can be used to provide an even better and up-to-date route by accessing ratings from other members of a social network. Additional advantages of the route finding system are that
it provides a much larger array of goals and constraints to choose from, both those that are pre-programmed and those from the review program; and
it permits the user to input their choices in a number of simple methods despite the large amount of choice and flexibility.

Although the invention herein has been described with reference to particular embodiments, it is to be understood that these embodiments are merely illustrative of the principles and applications of the present invention. It is therefore to be understood that numerous modifications may be made to the illustrative embodiments. For example, the optimal route can be expressed through an audio output or a visual display; the optimization algorithm used in route finding can be a simplex algorithm, interior-point algorithm, gradient-descent algorithm, etc; and consideration of other constraint factors such as bad weather, high-crime areas, roads prone to flooding, etc.

Thus, other arrangements may be devised without departing from the spirit and scope of the present invention as defined by the appended claims.

1. In a route finding system of the type, comprising:
(a) a route finding device having a memory, a processor, a GPS device, and a software means for route finding using an optimization algorithm;
(b) an electronic means to capture a user's inputs and store them in said memory;
(c) an output device to express a plurality of choices for the optimization goals, a plurality of choices for optimization constraints, and outputs of said route finding system to said user;
(d) the improvement comprising an electronic means for said user to specify their relative strength of preference among the choices for the optimization goals and constraints to be stored in said memory.

2. The system of claim 1 wherein said electronic means to capture a user's input and the means for preference indication are comprised of a graphical user interface to be shown on said display monitor.

3. The system of claim 1 wherein said electronic means to capture a user's input and the means for preference indication are comprised of a text-based interface to be shown on said display monitor.

4. The system of claim 1 wherein said electronic means to capture a user's input and the means for preference indication are comprised of a sound input, a sound output, and a software means for speech-recognition.

5. The system of claim 1 wherein said output device is a visual display.

6. The system of claim 1 wherein aid output device is an audio output. The system of claim 1 wherein the means for preference indication allows for multiple preferences to be indicated by the user.

7. The system of claim 1 further including an review program as a means for the user to rate and comment on road segments.

8. The system of claim 6 further including an internet connection and a network-based means for members of a social network to share their ratings and comments on road segments.

9. A process of operating a route finding system to execute a route finding program to find at least one route given two or more input points and at least one optimization goal, comprising the steps of:
(e) examining a plurality of alternative routes between said input points
(f) evaluating said alternative routes against said optimization goal and an optimal route is selected
(g) sending an optimal route to an output device

10. The process of claim 8 further comprising at least one optimization constraint is input by the user and said route finding program further comprises a step of penalizing said alternative routes which do not obey the constraint.

11. The process of claim 8 further comprising user input indications of relative preference of goals such that said route finding program further comprises a step converting said relative preferences into relative weights to be used in the evaluation against optimization goals.

12. The process of claim 9 further comprising user input indications of relative preference of constraints such that said route finding program further comprises a step converting said relative preferences into relative weights to be used in penalizing routes that do not obey constraints.

13. The process of claim 8 further comprising the step of converting graphical data into user-indicated goals, at least one constraint, and strength of preference.

14. The process of claim 8 further comprising the step of converting text into user-indicated goals, at least one constraint, and strength of preference.

15. The process of claim 11 further comprising the step of converting speech into user-indicated goals, constraints, and strength of preference.

16. The system of claim 8 wherein the step of sending said optimal route sends the optimal route to a visual display.

17. The system of claim 8 wherein the step of sending said optimal route sends the optimal route to an audio output.

18. The process of claim 8 further comprising the step of taking user input ratings and comments into a review program and to store them into said memory. The process of claim 15 further comprising the step of taking said ratings and comments and sharing them with other members of a social network.
